(19) United States
(12) Patent Application Publication
(10) Pub. No.: US 2020/0320939 A1
(43) Pub. Date: Oct. 8, 2020

(54) LIQUID CRYSTAL DISPLAY

(71) Applicant: Wuhan China Star Optoelectronics Technology Co., Ltd., Wuhan (CN)

(72) Inventors: Changwen Ma, Wuhan (CN); Guowei Zha, Wuhan (CN); Zhou Zhang, Wuhan (CN)

(21) Appl. No.: 16/308,812

(22) PCT Filed: Sep. 22, 2018
(86) PCT No.: PCT/CN2018/107149

§ 371 Date: Dec. 10, 2018

(30) Foreign Application Priority Data
May 18, 2018 (CN) 201810482888.5

(51) Int. Cl. G09G 3/34; G02F 1/13357; G09G 3/36

(52) U.S. Cl. CPC G09G 3/3406; G02F 1/133603; G09G 3/3648; G09G 2320/0626; G09G 2380/02; G09G 2370/08; G02F 2001/133612

(57) ABSTRACT

The invention provides an LCD, comprising a MINI LED substrate, a plurality of MINI LED chips disposed on one side of the MINI LED substrate, a MINI LED driving IC disposed on the other side of the MINI LED substrate, and a fluorescent film covering the plurality of MINI LED chips, the MINI LED driving IC driving the plurality of MINI LED chips to emit light. Compared to the prior art, the invention, without disposing the MINILED driving IC in FPCA, saves a connector, avoids the design space reduction in FPCA, and effectively reduces the routing difficulty of MINI LED driving IC and the plurality of MINI LED chips, thereby reduces the manufacturing cost.

### BACKGROUND OF THE INVENTION

### 1. Field of the Invention

The present invention relates to the field of display, and in particular to a liquid crystal display (LCD).

### 2. The Related Arts

With the rapid development of display technology, the panel display devices, such as, liquid crystal display (LCD), are widely used in various consumer electronic products, such as, personal digital assistants, digital cameras, notebook computers, and desktop computers, mobile phones, televisions, and so on, due to the advantages of high image quality, power saving, thinness and wide application range, and have become mainstream in display devices. Most of the LCDs on the market are backlight type LCD, which comprises an LCD panel and a backlight module. The operating principle of the LCD panel is to place liquid crystal (LC) molecules in two parallel glass substrates, with many vertical and horizontal thin wires between the two glass substrates, and the LC molecules are controlled to change direction by energizing the wires or not to refract the light of the backlight module to produce an image.

With the gradual rise of wearable applications, such as, smart glasses, smart watches, and so on, the demand on display industry for flexible display devices is also increasing. The organic light-emitting diode (OLED) display provides the properties of self-illumination without backlight, thinness and narrow frame. Faced with the competition of OLED, the traditional TFT LCD screen with the LED planar light source backlight display technology can effectively make up for existing shortcomings.

However, the prior art LED planar light source backlight display comprises an LED planar light source and a display panel, and the LED planar light source and the display panel are electrically connected by a flexible printed circuit assembly (FPCA), and the LED driving IC of the planar light source is usually disposed on the FPCA, and the FPCA needs to additionally provide a connector to electrically connect the LED driving IC to the LED chip on the LED planar light source, which undoubtedly reduces the space of the FPCA, and the wiring of the LED driving IC and the LED chip on the LED planar light source is more difficult, which greatly increases the manufacturing cost.

### SUMMARY OF THE INVENTION

The object of the present invention is to provide an LCD, able to reduce the difficulty of wiring the MINI LED driving IC and the MINI LED chip, reduce the production cost, and effectively improve the economic efficiency and productivity.

To achieve the above object, the present invention provides an LCD, which comprises: a display panel and a MINI LED planar light source for providing the display panel with backlight;

the MINI LED planar light source comprising a MINI LED substrate, a plurality of MINI LED chips disposed on one side of the MINI LED substrate, a MINI LED driving IC disposed on the other side of the MINI LED substrate, and a fluorescent film covering the plurality of MINI LED chips; the display panel comprising an FPCA; the MINI LED substrate being electrically connected to the FPCA, and the MINI LED driving IC driving the plurality of MINI LED chips to emit light.

The MINI LED planar light source further comprises an optical film assembly disposed between the fluorescent film and the display panel.

The display panel comprises a display driving IC, and the MINI LED driving IC is electrically connected to the display driving IC through the FPCA to receive a signal from the display driving IC.

The display driving IC comprises a driving algorithm of the MINI LED planar light source, and the driving algorithm of the MINI LED planar light source calculates a set of backlight coefficients according to a display image, and transmits the backlight coefficients to the MINI LED driving IC through the FPCA to control the brightness of the plurality of MINI LED chips.

The display panel comprises a circuit board IC, and the MINI LED driving IC is electrically connected to the circuit board IC through the FPCA to receive a signal from the circuit board IC.

The circuit board IC comprises a driving algorithm of a MINI LED planar light source, and the driving algorithm of the MINI LED planar light source calculates a set of backlight coefficients according to a display image, and transmits the backlight coefficients to the MINI LED driving IC through the FPCA to control the brightness of the plurality of MINI LED chips.

The display panel is a chip on glass (COG) display panel, and the display panel comprises an active area and a non-active area located around the active area, the non-active area is disposed with a display driving IC, the display driving IC and the FPCA are electrically connected.

The display panel is a chip on film (COF) display panel, and the display panel comprises an active area and a non-active area located around the active area, the non-active area comprises a COF, and the COF is disposed with a display driving IC, the display driving IC is electrically connected to the FPCA through the COF.

The MINI LED substrate comprises a planar light source active area and a planar light source non-active area located around the planar light source active area, and the planar light source non-active area comprises a planar light source interface electrically connected to the MINI LED driving IC, the planar light source interface is electrically connected to the FPCA.

The planar light source interface is electrically connected to the FPCA through a connector, soldering or heat pressing.

The present invention provides the following advantages: the invention provides an LCD, comprising a MINI LED substrate, a plurality of MINI LED chips disposed on one side of the MINI LED substrate, a MINI LED driving IC disposed on the other side of the MINI LED substrate, and a fluorescent film covering the plurality of MINI LED chips, the MINI LED driving IC driving the plurality of MINI LED chips to emit light. Compared to the prior art, the invention, without disposing the MINILED driving IC in FPCA, saves a connector, avoids the design space reduction in FPCA, and effectively reduces the routing difficulty of MINI LED driving IC and the plurality of MINI LED chips, thereby reduces the manufacturing cost.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the LCD of the present invention;

FIG. 2 is a schematic view showing the front of the LCD of the present invention;

FIG. 3 is a schematic view showing the display panel of the LCD of the first embodiment of the present invention;

FIG. 4 is a schematic view showing the display panel of the LCD of the second embodiment of the present invention;

FIG. 5 is a schematic view showing the driving algorithm of MINI LED planar light source of the LCD of the first embodiment of the present invention;

FIG. 6 is a schematic view showing the driving algorithm of MINI LED planar light source of the LCD of the second embodiment of the present invention.

### DETAILED DESCRIPTION OF THE PREFERRED EMBODIMENTS

To further explain the technical means and effect of the present invention, the following refers to embodiments and drawings for detailed description.

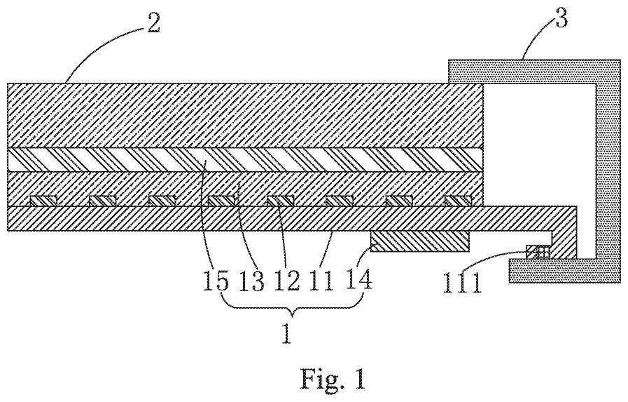

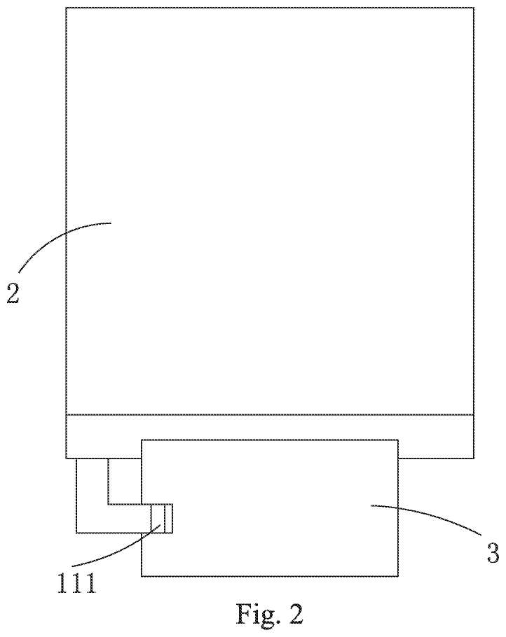

Refer to FIG. 1 and FIG. 2. The present invention provides an LCD, comprising: a display panel 2 and a MINI LED planar light source 1 for providing the display panel 2 with backlight.

The MINI LED planar light source 1 comprises a MINI LED substrate 11, a plurality of MINI LED chips 12 disposed on one side of the MINI LED substrate 11, a MINI LED driving IC 14 disposed on the other side of the MINI LED substrate 11, and a fluorescent film 13 covering the plurality of MINI LED chips 12; the display panel 2 comprises an FPCA 3; the MINI LED substrate 11 is electrically connected to the FPCA 3, and the MINI LED driving IC 14 drives the plurality of MINI LED chips 12 to emit light. As such, the MINI LED driving IC 14 is conveniently electrically connected to the plurality of MINI LED chips 12, which effectively reduces the difficulty of routing the MINI LED driving IC 14 and the plurality of MINI LED chips 12. Compared with the prior art. The present invention saves a connector, which reduces the manufacturing cost.

Specifically, the display panel 2 is disposed on a side of the fluorescent film 13 away from the plurality of MINI LED chips 12.

Specifically, the MINI LED substrate 11 is disposed with wires on both sides of the MINI LED chips 12 (i.e., away from and near the plurality of MINI LED chips 12), and the MINI LED driving IC 14 and the plurality of MINI LED chips 12 form an electrical connection through the wire.

Specifically, the MINI LED planar light source 1 further comprises an optical film assembly 15 disposed between the fluorescent film 13 and the display panel 2. Optionally, the optical film assembly 15 comprises a brightness enhancement film, a diffusion film, and so that, which can improve brightness and light-emission uniformity of the MINI LED planar light source 1.

Specifically, the MINI LED substrate 11 comprises a planar light source active area and a planar light source non-active area located around the planar light source active area, and the planar light source non-active area comprises a planar light source interface 111 electrically connected to the MINI LED driving IC 14, the planar light source interface 111 is electrically connected to the FPCA 3 through a connector, soldering or heat pressing. The planar light source interface 111 is electrically connected to the FPCA 3 and the MINI LED driving IC 14 is electrically connected to the FPCA 3 through the planar light source interface 111.

Specifically, the planar light source interface 111 comprises a planar light source power supply interface and a data interface.

Specifically, planar light source interface 111 is electrically connected to the FPCA 3 through the wires.

Specifically, the plurality of MINI LED chips 12 are arranged in an array.

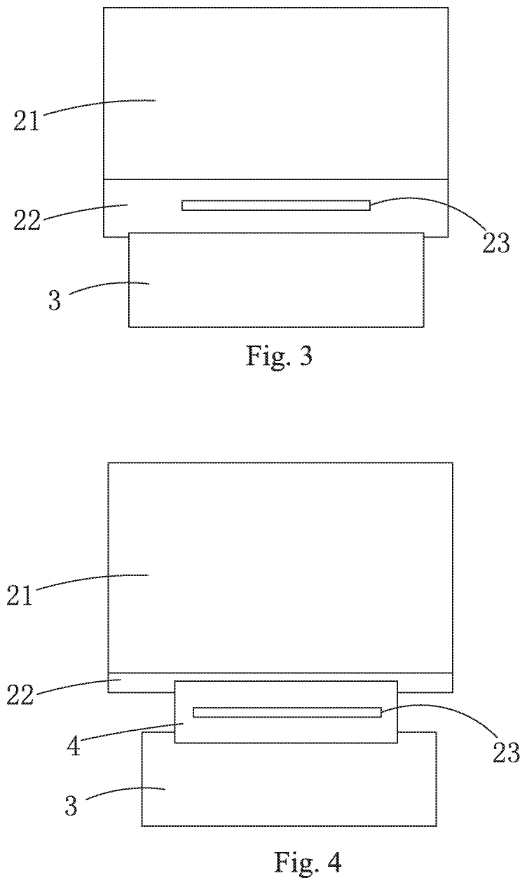

Specifically, FIG. 3 is a schematic view showing the display panel of the LCD of the first embodiment of the present invention. The display panel 2 is a COG display panel, and the display panel 2 comprises an active area 21 and a non-active area 22 located around the active area 21, the non-active area 22 is disposed with a display driving IC 23, the display driving IC 23 is for driving the display panel 2, the display driving IC 23 and the FPCA 3 are electrically connected.

Specifically, FIG. 4 is a schematic view showing the display panel of the LCD of the second embodiment of the present invention. The display panel 2 is a chip on film (COF) display panel, and the display panel 2 comprises an active area 21 and a non-active area 22 located around the active area 21, the non-active area 22 comprises a COF 4, and the COF 4 is disposed with a display driving IC 23, the display driving IC 23 is for driving the display panel 2. Because the display driving IC 23 is disposed on the COF 4, the non-active area 22 of the display panel 2 is smaller. As such, the present embodiment can realize the ultra-narrow border design of the display panel 2 so that the LCD is also ultra-narrow in border design. Moreover, the display driving IC 23 is electrically connected to the FPCA 3 through the COF 4 of the non-active area 22.

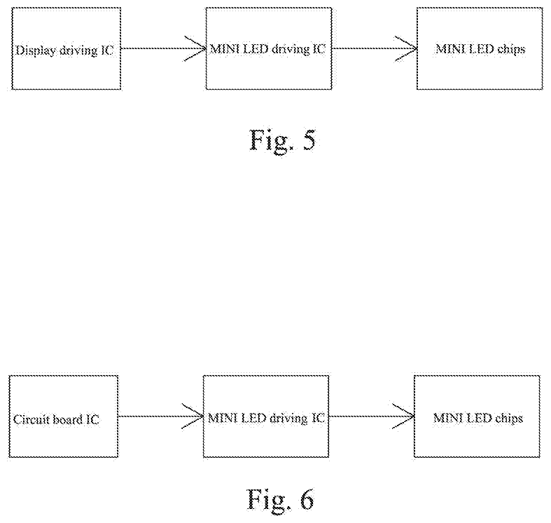

Specifically, as shown in FIG. 5, the MINI LED driving IC 14 is electrically connected to the display driving IC 23 through the FPCA 3 to receive a signal from the display driving IC 23. Moreover, the display driving IC 23 comprises a driving algorithm of the MINI LED planar light source, and the driving algorithm of the MINI LED planar light source calculates a set of backlight coefficients according to a display image, and transmits the backlight coefficients to the MINI LED driving IC 14 through the data interface to control the brightness of the plurality of MINI LED chips 12.

Specifically, as shown in FIG. 6, the display panel 2 comprises a circuit board IC, and the MINI LED driving IC 14 is electrically connected to the circuit board IC through the FPCA 3 to receive a signal from the circuit board IC. The circuit board IC comprises a driving algorithm of a MINI LED planar light source, and the driving algorithm of the MINI LED planar light source calculates a set of backlight coefficients according to a display image, and transmits the backlight coefficients to the MINI LED driving IC 14 through the data interface to control the brightness of the plurality of MINI LED chips 12. Preferably, the planar light source interface 111 is electrically connected to the FPCA 3 through a connector.

In summary, the invention provides an LCD, comprising a MINI LED substrate, a plurality of MINI LED chips disposed on one side of the MINI LED substrate, a MINI LED driving IC disposed on the other side of the MINI LED substrate, and a fluorescent film covering the plurality of MINI LED chips, the MINI LED driving IC driving the plurality of MINI LED chips to emit light. Compared to the prior art, the invention, without disposing the MINILED driving IC in FPCA, saves a connector, avoids the design space reduction in FPCA, and effectively reduces the routing difficulty of MINI LED driving IC and the plurality of MINI LED chips, thereby reduces the manufacturing cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A liquid crystal display (LCD), comprising: a display panel and a MINI light-emitting diode (LED) planar light source for providing the display panel with backlight;
the MINI LED planar light source comprising a MINI LED substrate, a plurality of MINI LED chips disposed on one side of the MINI LED substrate, a MINI LED driving integrated circuit (IC) disposed on the other side of the MINI LED substrate, and a fluorescent film covering the plurality of MINI LED chips; the display panel comprising a flexible printed circuit assembly (FPCA); the MINI LED substrate being electrically connected to the FPCA, and the MINI LED driving IC driving the plurality of MINI LED chips to emit light.

2. The LCD as claimed in claim 1, wherein the MINI LED planar light source further comprises an optical film assembly disposed between the fluorescent film and the display panel.

3. The LCD as claimed in claim 1, wherein the display panel comprises a display driving IC, and the MINI LED driving IC is electrically connected to the display driving IC through the FPCA to receive a signal from the display driving IC.

4. The LCD as claimed in claim 3, wherein the display driving IC comprises a driving algorithm of the MINI LED planar light source, and the driving algorithm of the MINI LED planar light source calculates a set of backlight coefficients according to a display image, and transmits the backlight coefficients to the MINI LED driving IC through the FPCA to control the brightness of the plurality of MINI LED chips.

5. The LCD as claimed in claim 1, wherein the display panel comprises a circuit board IC, and the MINI LED driving IC is electrically connected to the circuit board IC through the FPCA to receive a signal from the circuit board IC.

6. The LCD as claimed in claim 5, wherein the circuit board IC comprises a driving algorithm of a MINI LED planar light source, and the driving algorithm of the MINI LED planar light source calculates a set of backlight coefficients according to a display image, and transmits the backlight coefficients to the MINI LED driving IC through the FPCA to control the brightness of the plurality of MINI LED chips.

7. The LCD as claimed in claim 1, wherein the display panel is a chip on glass (COG) display panel, and the display panel comprises an active area and a non-active area located around the active area, the non-active area is disposed with a display driving IC, the display driving IC and the FPCA are electrically connected.

8. The LCD as claimed in claim 1, wherein the display panel is a chip on film (COF) display panel, and the display panel comprises an active area and a non-active area located around the active area, the non-active area comprises a COF, and the COF is disposed with a display driving IC, the display driving IC is electrically connected to the FPCA through the COF.

9. The LCD as claimed in claim 1, wherein the MINI LED substrate comprises a planar light source active area and a planar light source non-active area located around the planar light source active area, and the planar light source non-active area comprises a planar light source interface electrically connected to the MINI LED driving IC, the planar light source interface is electrically connected to the FPCA.

10. The LCD as claimed in claim 9, wherein the planar light source interface is electrically connected to the FPCA through a connector, soldering or heat pressing.
